(19) United States
(12) Patent Application Publication
(10) Pub. No.: US 2026/0134342 A1
(43) Pub. Date: May 14, 2026

(54) MACHINE LEARNING-BASED FEDERATED LEARNING METHOD AND COMPUTING DEVICE FOR PERFORMING THE SAME

(71) Applicant: University-Industry Cooperation Group of Kyung Hee University, Gyeonggi-do (KR)

(72) Inventors: CHOONG SEON HONG, Gyeonggi-do (KR); YU QIAO, Gyeonggi-do (KR); APURBA ADHIKARY, Gyeonggi-do (KR); QUANG HUY LE, Gyeonggi-do (KR); HA EUN SONG, Gyeonggi-do (KR)

(21) Appl. No.: 18/948,693

(22) Filed: Nov. 15, 2024

(30) Foreign Application Priority Data
Nov. 8, 2024 (KR) 10-2024-0158485

(51) Int. Cl. G06N 20/00

(52) U.S. Cl. CPC G06N 20/00

(57) ABSTRACT

A computing device is a local device that includes one or more processors and a memory which stores one or more programs executed by the processors and executes a machine learning model. The one or more programs include an instruction for inputting input samples labeled to the machine learning model to generate feature vectors from each of the input samples, an instruction for local clustering the feature vectors based on labeling values, an instruction for generating local representative vectors representing each of the local clusters generated by the local clustering to transmit them to a server, an instruction for receiving global representative vectors generated based on the local representative vectors collected from the local devices from the server, and an instruction for global contrastive learning on the machine learning model based on the global representative vectors and the plurality of feature vectors.

### CROSS-REFERENCE TO RELATED APPLICATION AND CLAIM OF PRIORITY

This application claims the benefit under 35 USC § 119 of Korean Patent Application No. 10-2024-0158485, filed on Nov. 8, 2024, in the Korean Intellectual Property Office, the entire disclosure of which is incorporated herein by reference for all purposes.

### BACKGROUND

### 1. Technical Field

The examples of the present invention relate to a machine learning-based federated learning method and a computing device technology for performing the same.

### 2. Background Art

With proliferation of smart devices, data processing efficiency in a distributed network environment is becoming important. For efficient data processing in the distributed network environment, Mobile Edge Computing (MEC) is being utilized, instead of the conventional cloud computing method. Among the mobile edge computing methods, federated learning (FL) is one kind of machine learning technologies, which is a method for guaranteeing the privacy of local clients by learning locally without transmitting data to a server. However, the conventional federated learning method has a problem that performance degradation occurs due to learning biased toward a specific local client, when the data distribution among a plurality of local clients is not the same. Accordingly, a federated learning method that can be independent of data imbalance between local clients is required.

### SUMMARY

An aspect of the present invention is to provide a machine learning-based federated learning method which can be independent of data imbalance between local clients.

Another aspect of the present invention is to provide a federated learning method with improved performance by solving the above problems.

The objects of the present invention are not limited to the objects mentioned above, and other objects and advantages of the present description which are not mentioned can be understood by the following description, and may be more clearly understood by examples of the present description. In addition, it can be easily understood that the objects and advantages of the present description can be realized by the means shown in claims and combinations thereof.

The computing device according to one example disclosed, is a computing device which is a local device that includes one or more processors and a memory which stores one or more programs executed by the processors, and executes a machine learning model, and one or more programs include an instruction for inputting a plurality of input samples labeled to the machine learning model to generate feature vectors from each of the input samples, an instruction for local clustering the plurality of feature vectors based on labeling values, an instruction for generating local representative vectors representing each of the plurality of local clusters generated by the local clustering to transmit them to a server, an instruction for receiving a plurality of global representative vectors generated based on the plurality of local representative vectors collected from the plurality of local devices from the server, and an instruction for global contrastive learning on the machine learning model based on the plurality of global representative vectors and the plurality of feature vectors.

The instruction for local clustering may include an instruction for generating local clusters by clustering the plurality of feature vectors between those having the same labeling value.

The global representative vectors may be calculated based on each global cluster generated by the global clustering by global clustering the plurality of local representative vectors.

The instruction for global contrastive learning, may include an instruction for learning by a global contrastive loss function that makes the distance between the feature vector and the global representative vector which have the same labeling value become closer, and makes the distance between the feature vector and the global representative vector which have different labeling values become more distant.

The one or more programs may further include an instruction for supervised learning the machine learning model by a supervised loss function indicating the difference between the feature vector and the labeling value.

The one or more programs may further include an instruction for local contrastive learning on the machine learning model based on the plurality of local representative vectors and the plurality of feature vectors.

The instruction for local contrastive learning, may include an instruction for learning by a local contrastive loss function that makes the distance between the feature vector and the local representative vector which have the same labeling value become closer, and makes the distance between the feature vector and the local representative vector which have different labeling values become more distant.

The federated learning method according to one example disclosed is a method performed in a computing device which is a local device that executes a machine learning model and includes one or more processors and a memory which stores one or more programs executed by the processors, and it includes inputting a plurality of input samples labeled to the machine learning model to generate feature vectors from each of the input samples, local clustering each of the feature vectors based on labeling values, generating local representative vectors representing each of the plurality of local clusters generated by the local clustering to transmit them to a server, receiving a plurality of global representative vectors generated based on the plurality of local representative vectors collected from the plurality of local devices from the server, and global contrastive learning on the machine learning model based on the plurality of global representative vectors and the plurality of feature vectors.

The federated learning method according to one example disclosed is a method performed in a computing device including one or more processors and a memory which stores one or more programs executed by the processors, and it includes receiving a plurality of local representative vectors generated based on a plurality of feature vectors corresponding to a plurality of input samples from local devices, global clustering the plurality of local representative vectors received from the plurality of the local devices based on labeling values, generating global representative vectors representing each of the plurality of global clusters generated by the global clustering, and instructing global contrastive learning on the machine learning model executed by the local devices, based on the plurality of global representative vectors and the plurality of feature vectors, to each of the plurality of local devices.

According to one example disclosed, a machine learning-based federated learning method which can be independent of data imbalance between local clients can be provided.

According to the above effects, the performance of the federated learning technology can be improved.

### BRIEF DESCRIPTION OF THE DRAWINGS

The present disclosure can be easily understood by combination of the following detailed description and accompanying drawings thereto, and reference numerals mean structural elements.

FIG. 1 is a drawing which shows a system that performs machine learning-based federated learning, according to one example.

FIG. 2 is a schematic diagram for describing the machine learning-based federated learning method, according to one example.

FIG. 3 is a flow chart showing the machine learning-based federated learning method, according to one example.

FIG. 4 is a block diagram showing the configuration of the computing device, according to one example.

### DETAILED DESCRIPTION

Hereinafter, specific embodiments of the present invention will be described with reference to drawings. The following detailed description is provided to help a comprehensive understanding of the methods, devices, and/or systems described in the present description. However, these are only examples, and the present invention is not limited thereto.

In describing the examples of the present invention, when it is judged that a detailed description of the prior art related to the present invention may unnecessarily obscure the gist of the present invention, the detailed description will be omitted. In addition, the terms described below are terms defined in consideration of their functions in the present invention, and may vary depending on the intention of the user or operator or custom or the like. Therefore, the definitions should be made based on the contents throughout the present description. The terms used in the detailed description are only for describing the examples of the present invention, and should never be limited. Unless clearly used otherwise, expressions in the singular form include the meaning of the plural form. In the present description, expressions such as “including” or “having” are intended to indicate certain characteristics, numbers, steps, operations, elements, parts or combinations thereof, and it should not be interpreted to exclude the existence or possibility of one or more other characteristics, numbers, steps, operations, elements, parts or combinations thereof other than those described.

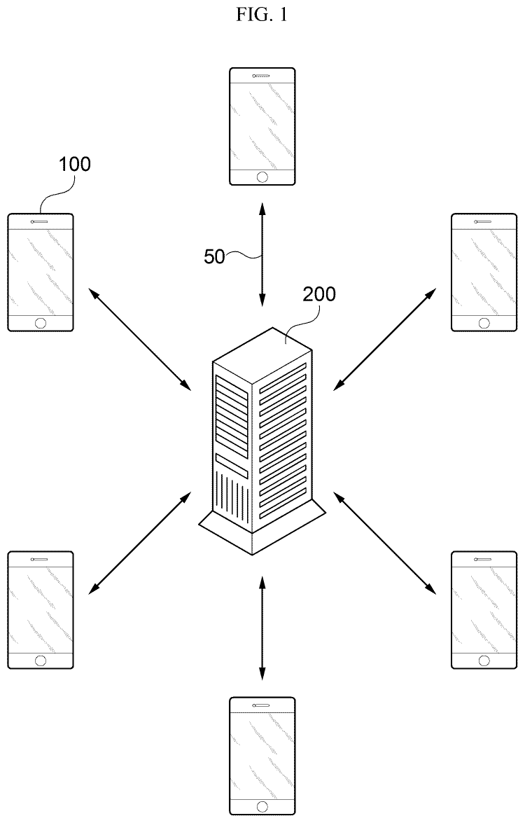

FIG. 1 is a drawing which shows a system that performs machine learning-based federated learning, according to one example.

Referring to FIG. 1, the system that performs machine learning-based federated learning may include local devices (100) and a server (200). The plurality of local devices (100) may be provided with artificial intelligence-based services from the server (200). Each of the local devices (100) may communicate with the server (200) in order to be provided with optimized (learned) services through artificial intelligence technology. Then, each of the local devices (100) may be connected to the server (200) by a communication network (50) to communicate.

In an exemplary example, the communication network (50) may include internet, one or more local area networks, wide area networks, cellular networks, mobile networks, other different types of networks, or combinations of these networks.

The local devices (100) may execute a machine learning model for implementing services provided by the server. The plurality of local devices (100) which execute the same machine learning model may be connected to one server. Each of the local devices (100) may transmit data to learn the machine learning model to the server (200).

In an exemplary example, the local devices (100) may include a processor that executes a machine learning model. The local devices (100) may include various electronic equipment that has a display and can communicate with the server (100). For example, the local devices (100) may include a smart phone, a tablet PC, a laptop computer (notebook PC), a desktop personal computer, a PDA (personal digital assistant), and a wearable device such as a smart watch, an electronic book terminal, a smart glass, a portable game console, a navigation, a digital camera, and the like.

The server (200) may be connected to the plurality of local devices (100) which drive services by the communication network (50). The server (200) may generate data for learning a machine learning model executed in the local devices (100), federatedly considering data received from the plurality of local devise (100). The server (200) may transmit data for learning a machine learning model to each of the local devices (100).

In an exemplary example, the server (200) may include one or more processors required for generating data for learning a machine learning model and a computer readable recording medium connected to the processors, and further include a database for storing data. The computer readable recording medium may be inside or outside of the processors, and may be connected with the processors by well-known various means. The processors in the server (200) may make the server (200) operate according to exemplary examples described in the present description. For example, the processors may execute instructions stored in the computer readable recording medium, and the instructions stored in the computer readable recording medium may be configured to make the server (200) perform operations according to the exemplary examples described in the present description, when executed by the processors.

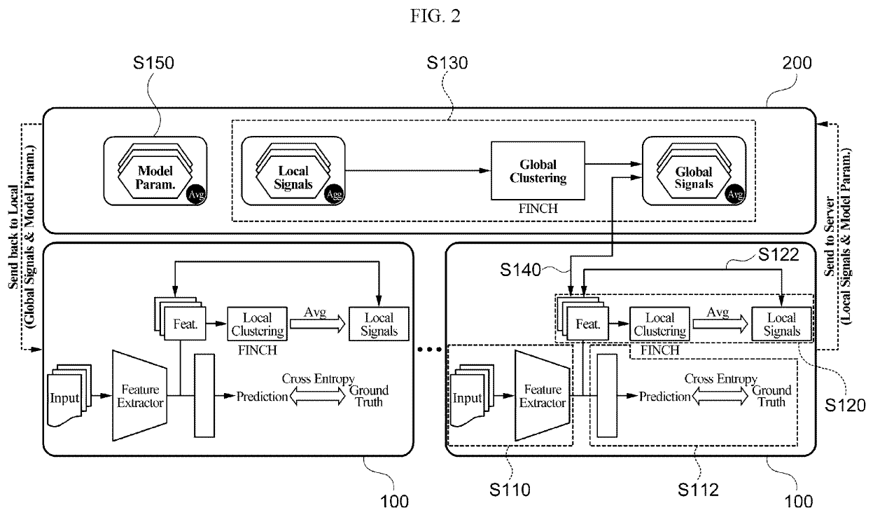

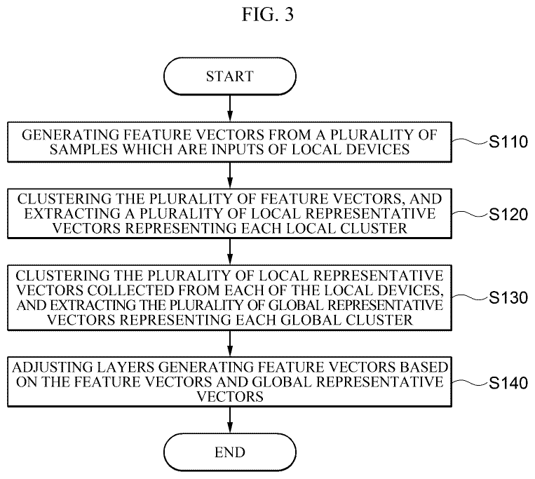

FIG. 2 is a schematic diagram for describing the machine learning-based federated learning method, according to one example, and FIG. 3 is a flow chart showing the machine learning-based federated learning method, according to one example. The method illustrated in FIG. 2 and FIG. 3 may be performed by for example, at least one of the afore-mentioned local devices (100) and the server (200). In addition, the method illustrated in FIG. 2 and FIG. 3 may be performed by for example, the computing device (12) described later. In the illustrated flow chart, the method was described by dividing into a plurality of steps, but at least some steps may be performed by changing the order, performed by being combined to other steps together, omitted, performed by dividing into substeps, or performed by adding one or more steps which are not shown.

Referring to FIG. 2 and FIG. 3, the machine learning-based federated learning method may include generating feature vectors from a plurality of samples which are inputs of local devices (S110), clustering the plurality of feature vectors and extracting a plurality of local representative vectors representing each local cluster (S120), clustering the plurality of local representative vectors collected from each of the local devices, and extracting a plurality of global representative vectors representing each global cluster (S130) and adjusting layers which generate feature vectors based on the feature vectors and global representative vectors (S140).

The local devices (100) may execute a machine learning model. In an exemplary example, the machine learning model may be a model that classifies inputted samples. The machine learning model may be provided into a user by predicting the classification results of the inputted samples. For example, the machine learning model may receive inputs of various animal photographs in image format and predict which animals the corresponding photos belong to. Otherwise, the machine learning model can receive inputs of X-ray images for medical diagnosis and predict which disease the corresponding X-ray images are images including.

The machine learning model may include a neural network structure formed with a plurality of neurons and layers. The neural network may include one or more layers that perform preset functions. Each of the one or more layers may include multiple neurons which are minimal units for processing input data.

In the step S110, the local devices (100) may generate feature vectors from a plurality of samples which are inputs of the local devices. Specific contents are as follows. The local device (100) may receive inputs of the plurality of samples. The inputted samples may be labeled for the results about information indicated by the samples. For example, for an image representing a puppy, the text “puppy” may be designated as the labeling value.

The local devices (100) may generate feature vectors showing characteristics of each sample for each of the plurality of samples. The generated feature vectors may be a target of learning. The local devices (100) may generate feature vectors corresponding to each sample by passing the plurality of samples through feature extract layers that extract characteristics.

In addition, in the step S112, the local devices (100) may adjust the layers generating feature vectors, based on the labeling data of the feature vectors and samples. In other words, the local devices (100) may perform supervised learning for the feature vectors. Specific contents are as follows.

The local devices (100) may calculate feature vectors for an inputted sample, and calculate prediction values (predictions) regarding information represented by the corresponding sample. In an exemplary example, the local device inputted with an animal photograph may calculate a prediction value for the result of predicting what kind of animal the photograph represents.

The local devices (100) may compare the prediction value and labeling value (ground truth) for the inputted sample. The local devices (100) may adjust layers that generate feature vectors so that the prediction value and labeling value become similar. In an exemplary example, the layers that generate feature vectors may be adjusted so that the feature vector of the sample of which labeling value is “puppy” has a prediction value of “puppy”. Specifically, the local devices (100) may adjust values of factors included in the layers that generate feature vectors so that the difference value (Loss1) of the prediction value and labeling value becomes closer to 0 (zero).

In the step S120, the local devices (100) may cluster a plurality of feature vectors, and extract a plurality of local representative vectors representing each local cluster. Specific contents are as follows. The local devices (100) may perform clustering (grouping) ones with the sample labeling value of samples corresponding to the plurality of feature vectors. As the result of clustering, a plurality of clusters at a local level (hereinafter, local clusters) may be generated.

In an exemplary example, the clustering may be one or more of FINCH clustering (FINCH, fully INCremental hierarchical clustering), K-means clustering, hierarchical clustering, density-based clustering (DBSCAN, density-based spatial clustering of applications with noise), GMM clustering (gaussian mixture model) and spectral clustering.

The local devices (100) may generate local representative vectors representing local clusters per each local cluster. In an exemplary example, the local devices (100) may generate local representative vectors by averaging the plurality of feature vectors in each local cluster. The local devices (100) may transmit local representative vectors of each of the plurality of local clusters into the server (200).

In addition, in the step S122, the local devices (100) may adjust layers that generate feature vectors, based on the feature vectors and local representative vectors. In other words, the local devices (100) may perform a first contrastive learning (local contrastive learning) for the feature vectors and the local representative vectors. Specific contents are as follows.

The local devices (100) may compare feature vectors of inputted samples with the local representative vector of each cluster. The local devices (100) may match a local representative vector having the same labeling value as a feature vector and designate it as a first positive pair. In other words, the first positive pair may include a feature vector and a local representative vector of the same class as the feature vector.

Similarly, the local devices (100) may match a local representative vector having a different labeling value from a feature vector and designate a first negative pair. In other words, the first negative pair may include a feature vector and a local representative vector of a different class from the feature vector.

The local devices (100) may perform the first contrastive learning (local contrastive learning) so that the distance between the first positive pair becomes closer and the distance between the first negative pair becomes more distant. Specifically, a loss function by the first contrastive learning (Loss2) may be set so as to be closer to 0 (zero) as the distance between the first positive pair is closer and the distance between the first negative pair is more distant. The local devices (100) may adjust values of factors included in the layers that generate feature vectors so that the first contrastive loss function (Loss2) becomes closer to 0 (zero).

In the step S130, the server (200) may cluster a plurality of local representative vectors collected from each of the local devices, and extract a plurality of global representative vectors representing each global cluster. Specific contents are as follows. The server (200) may collect local representative vectors from each of the plurality of local devices (100). For example, when M local representative vectors are collected from each of N local devices (100), the server (200) may obtain N*M local representative vectors in total. The server (200) may designate the collected local representative vectors as a set as a global representative vector pool (global prototypes pool).

The server (200) may perform clustering (grouping) ones with the same labeling value of the corresponding sample for the plurality of local representative vectors of the global representative vector pool. As the result of clustering, a plurality of clusters at a global level (hereinafter, global clusters) may be generated. Specific examples for the clustering method are omitted as they are same as in the S120 step above.

The server (200) may generate global representative vectors representing global clusters per each global cluster. In an exemplary example, the server (200) may generate global representative vectors by averaging the plurality of local representative vectors in each global cluster. The server (200) may prevent learning performance degradation by data imbalance by different data amounts per local device (100), as it does not directly use the global representative vector pool as the target of learning, but clusters each labeling value unit, and selects a representative (global representative vector) for each cluster, and uses the selected representative as the target of learning. The server (200) may transmit the global representative vector of each of the plurality of global clusters to the local devices (100).

In the step S140, the local devices (100) may adjust layers that generate feature vectors based on the feature vectors and global representative vectors. In other words, the local devices (100) may perform a second contrastive learning (global contrastive learning) for the feature vectors and global representative vectors. Specific contents are as follows.

The local devices (100) may receive the plurality of global representative vectors from the server (200). The local devices (100) may compare the feature vectors each of the received plurality of global representative vectors. The local devices (100) may match a global representative vector having the same labeling value as a feature vector and designate a second positive pair. In other words, the second positive pair may include a feature vector and a global representative vector of the same class as the feature vector.

Similarly, the local devices (100) may match a global representative vector having a different labeling value from a feature vector and designate a second negative pair. In other words, the second negative pair may include a feature vector and a global representative vector of a different class from the feature vector.

The local device (100) may perform the second contrastive learning (global contrastive learning) so that the distance between the second positive pair becomes closer and the distance between the second negative pair becomes more distant. Specifically, a loss function by the second contrastive learning (Loss3) may be set so as to be closer to 0 (zero) as the distance between the second positive pair is closer and the distance between the second negative pair is more distant. The local devices (100) may adjust values of factors included in the layers that generate feature vectors so that the second contrastive loss function (Loss3) becomes closer to 0 (zero).

Furthermore, in the step S150, the server (200) may generate model parameters that suggest the learning direction of the machine learning model of the local devices (100) based on the learning result of the local supervised learning (step S112), local contrastive learning (step S122) and global contrastive learning (step S140), and provide this to each local device (100). Specifically, the server (200) may collect learning result data of the local devices (100) based on the learning result of the local supervised learning (step S112), local contrastive learning (step S122) and global contrastive learning (step S140) from each local device (100). The server (200) may generate model parameters that suggest the learning direction of all the local devices (100) based on the learning result data collected from each local device (100). The server (200) may transmit the model parameters to each local device (100). Each local device (100) may learn the machine learning model based on the received model parameters.

The local devices (100) may perform machine learning by model parameters, and then perform the federated learning method of Step S110 to Step S150 again.

According to one example disclosed, a machine learning-based federated learning method which can be independent of data imbalance between local clients can be provided. According to the above effects, the performance of the federated learning technology can be improved.

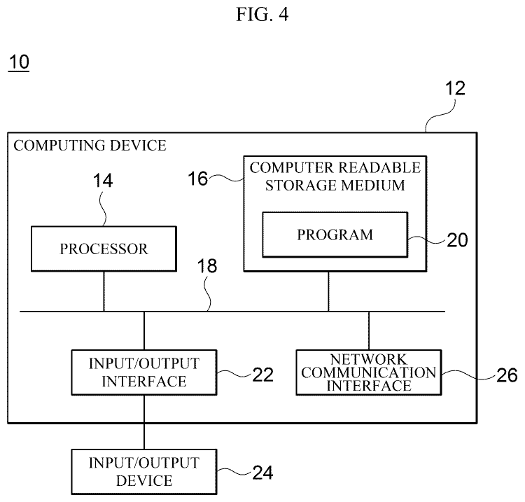

FIG. 4 is a block diagram showing the configuration of the computing device, according to one example. In the illustrated example, each component may have different functions and capabilities other than those described below, and may include additional components other than those described below.

The illustrated computing environment (10) includes a computing device (12). In one example, the computing device (12) may be the afore-mentioned local device (100), and may perform the role of the local device (100) in the machine learning-based federated learning method described in FIG. 1 to FIG. 3.

In addition, in one example, the computing device (12) may be the afore-mentioned server (200), and may perform the role of the server (200) in the machine learning-based federated learning method described in FIG. 1 to FIG. 3.

The computing device (12) includes at least one processor (14), a computer readable storage medium (16) and a communication bus (18). The processor (14) may make the computing device (12) to operate according to the afore-mentioned exemplary examples. For example, the processor (14) may execute one or more programs stored in the computer readable storage medium (16). The one or more programs may include one or more computer executable instructions, and the computer executable instructions may be configured to make the computing device (12) to perform operations according to the exemplary examples, when executed by the processor (14).

The computer readable storage medium (16) is configured to store computer executable instructions or program codes, program data and/or other suitable forms of information. The programs (20) stored in the computer readable storage medium (16) include a set of instructions executable by the processor (14). In one example, the computer readable storage medium (16) may be a memory (volatile memory such as a random-access memory, non-volatile memory, or a suitable combination thereof), one or more magnetic disk storage devices, optical disk storage devices, flash memory devices, other forms of storage media that are accessed by the computing device (12) and store desired information, or a suitable combination thereof.

The communication bus (18) interconnects other various components of the computing device (12) by including the processor (14) and computer readable storage medium (16).

The computing device (12) may include one or more input/output interfaces (22) that provide interfaces for one or more input/output devices (24) and one or more network communication interfaces (26). The input/output interfaces (22) and network communication interfaces (26) are connected to the communication bus (18). The input/output devices (24) may be connected to other components of the computing device (12) through the input/output interfaces (22). The illustrative input/output devices (24) may include input devices such as pointing devices (mouse or trackpad, etc.), keyboards, touch input devices (touchpad or touchscreen, etc.), voice or sound input devices, various kinds of sensor devices and/or photographing devices, and/or output devices such as display devices, printers, speakers, and/or network cards. The illustrative input/output devices (24) may be included inside the computing device (12) as one component, and may be connected with the computing device (12) as a separate device distinguished from the computing device (12).

Representative examples of the present invention have been described in detail above, but those skilled in the art will understand that various modifications can be made to the afore-mentioned examples without departing from the scope of the present invention. Therefore, the scope of the present invention should not be limited to the described examples, and should be determined not only by the claims described below but also by equivalents of these claims.

What is claimed is:

1. A computing device which is a local device, the computing device comprising:
one or more processors; and
a non-transitory memory which stores one or more programs executed by the processors, and executes a machine learning model, the one or more programs comprising:
an instruction for inputting a plurality of input samples labeled to the machine learning model to generate feature vectors from each of the input samples;
an instruction for local clustering the plurality of feature vectors based on labeling values;
an instruction for generating local representative vectors representing each of the plurality of local clusters generated by the local clustering to transmit them to a server;
an instruction for receiving a plurality of global representative vectors generated based on the plurality of local representative vectors collected from the plurality of local devices from the server; and
an instruction for global contrastive learning on the machine learning model based on the plurality of global representative vectors and the plurality of feature vectors.

2. The computing device according to claim 1, wherein the instruction for local clustering comprises an instruction for generating local clusters by clustering the plurality of feature vectors between those having the same labeling value.

3. The computing device according to claim 1, wherein the global representative vectors are calculated based on each global cluster generated by the global clustering by global clustering the plurality of local representative vectors.

4. The computing device according to claim 1, wherein the instruction for global contrastive learning comprises an instruction for learning by a global contrastive loss function that makes the distance between the feature vector and the global representative vector which have the same labeling value become closer, and makes the distance between the feature vector and the global representative vector which have different labeling values become more distant.

5. The computing device according to claim 1, wherein the one or more programs further comprise an instruction for supervised learning the machine learning model by a supervised loss function indicating the difference between the feature vector and the labeling value.

6. The computing device according to claim 1, wherein the one or more programs further comprise an instruction for local contrastive learning on the machine learning model based on the plurality of local representative vectors and the plurality of feature vectors.

7. The computing device according to claim 6, wherein the instruction for local contrastive learning comprises an instruction for learning by a local contrastive loss function that makes the distance between the feature vector and the local representative vector which have the same labeling value become closer, and makes the distance between the feature vector and the local representative vector which have different labeling values become more distant.

8. A federated learning method, performed in a computing device which is a local device that executes a machine learning model and comprises one or more processors and a memory which stores one or more programs executed by the processors, the federated learning method comprising:
inputting a plurality of input samples labeled to the machine learning model to generate feature vectors from each of the input samples;
local clustering each of the feature vectors based on labeling values;
generating local representative vectors representing each of the plurality of local clusters generated by the local clustering to transmit them to a server;
receiving a plurality of global representative vectors generated based on the plurality of local representative vectors collected from the plurality of local devices from the server; and
global contrastive learning on the machine learning model based on the plurality of global representative vectors and the plurality of feature vectors.

9. The federated learning method according to claim 8, wherein the local clustering comprises generating local clusters by clustering the plurality of feature vectors between those having the same labeling value.

10. The federated learning method according to claim 8, wherein the global representative vectors are calculated based on each global cluster generated by the global clustering by global clustering the plurality of local representative vectors.

11. The federated learning method according to claim 8, wherein the global contrastive learning comprises learning by a global contrastive loss function that makes the distance between the feature vector and the global representative vector which have the same labeling value become closer, and makes the distance between the feature vector and the global representative vector which have different labeling values become more distant.

12. The federated learning method according to claim 8, wherein an operation method of the local device further comprises supervised learning the machine learning model by a supervised loss function indicating the difference between the feature vector and the labeling value.

13. The federated learning method according to claim 8, wherein an operation method of the local device further comprises local contrastive learning on the machine learning model based on the plurality of local representative vectors and the plurality of feature vectors.

14. The federated learning method according to claim 13, wherein the local contrastive learning comprises learning by a local contrastive loss function that makes the distance between the feature vector and the local representative vector which have the same labeling value become closer, and makes the distance between the feature vector and the local representative vector which have different labeling values become more distant.

15. A federated learning method, performed in a computing device comprising one or more processors and a memory which stores one or more programs executed by the processors, the federated learning method comprising:
receiving a plurality of local representative vectors generated based on a plurality of feature vectors corresponding to a plurality of input samples from local devices;
global clustering the plurality of local representative vectors received from the plurality of the local devices based on labeling values;
generating global representative vectors representing each of the plurality of global clusters generated by the global clustering; and
instructing global contrastive learning on the machine learning model executed by the local devices, based on the plurality of global representative vectors and the plurality of feature vectors, to each of the plurality of local devices.

16. The federated learning method according to claim 15, wherein the local representative vectors are calculated based on each local cluster generated by the local clustering by local clustering the plurality of feature vectors.

17. The federated learning method according to claim 15, wherein the instructing global contrastive learning comprises instructing learning by a global contrastive loss function that makes the distance between the feature vector and the global representative vector which have the same labeling value become closer, and makes the distance between the feature vector and the global representative vector which have different labeling values become more distant.

18. The federated learning method according to claim 15, wherein the federated learning method further comprises instructing local contrastive learning on the machine learning model based on the plurality of local representative vectors and the plurality of feature vectors to each of the plurality of local devices.

19. The federated learning method according to claim 15, wherein the federated learning method further comprises instructing supervised learning based on the plurality of feature vectors and the plurality of labeling values to each of the plurality of local devices;
instructing local contrastive learning on the machine learning model based on the plurality of local representative vectors and the plurality of feature vectors to each of the plurality of local devices;
receiving results of each of the global contrastive learning, the supervised learning and the local contrastive learning from each of the plurality of local devices; and
calculating model parameters to make the local devices learn a machine learning model based on the received results of each learning.
